(19) United States
(12) Patent Application Publication
(10) Pub. No.: US 2022/0385534 A1
(43) Pub. Date: Dec. 1, 2022

(54) CONTROL PLANE ISOLATION

(71) Applicant: Intel Corporation, Santa Clara, CA (US)

(72) Inventors: Elazar COHEN, Haifa (IL); Keren GUY, Sunnyvale, CA (US); Marina POPILOV, Herzlia (IL); Andrey CHILIKIN, Limerick (IE)

(21) Appl. No.: 17/882,317

(22) Filed: Aug. 5, 2022

Related U.S. Application Data
(63) Continuation-in-part of application No. 17/670,355, filed on Feb. 11, 2022.

(51) Int. Cl. H04L 41/08; H04L 41/0894; H04L 41/0816

(52) U.S. Cl. CPC H04L 41/0883; H04L 41/0894; H04L 41/0816

(57) ABSTRACT

Examples described herein relate to a network interface device comprising circuitry and data plane circuitry. In some examples, the circuitry is to receive control configurations from multiple control planes and based on a management configuration, selectively deny a control configuration of the received control configurations to configure operations of the data plane circuitry. In some examples, selectively denying the control configuration comprises restrict different control planes from modification of configuration of the data plane circuitry

### RELATED APPLICATION

The present application is a continuation-in-part of U.S. patent application Ser. No. 17/670,355, filed Feb. 11, 2022 (Attorney Docket Number AD9072-US). The contents of that application are incorporated herein in their entirety.

### BACKGROUND

In a datacenter, some network interface devices include programmable data planes that are configurable by a control plane. The control plane can configure the programmable data planes with certain rules of operation so that the network interface device can independently perform packet processing operations.

### BRIEF DESCRIPTION OF THE DRAWINGS

FIG. 1 depicts an example system.

FIG. 2 depicts an example system.

FIG. 3 depicts an example process.

FIGS. 4A-4C depict example operations.

FIG. 5 depicts an example process.

FIG. 6 depicts an example network interface device.

FIG. 7 depicts an example packet processing device.

FIG. 8 depicts an example system.

FIG. 9 depicts an example system.

### DETAILED DESCRIPTION

In a system in which multiple control planes can configure a packet processing pipeline, a last applied configuration overrides a prior configuration and configures the packet processing pipeline. Accordingly, multiple and logically independent control plane entities (e.g., control plane software, end-users, or applications) might interfere with configurations of one another. Untrusted control plane entries can intentionally or mistakenly intervene to configure resources (e.g., counters, actions, filters, destinations, policers, and others) of another control plane entity, potentially causing a flood of unexpected traffic, shared counters, broken filters, or other malfunction.

At least to provide for control over configuration of actions of a data plane circuitry in a network interface device, the network interface device can include circuitry configured to apply or deny received control configurations at the data plane packet processing circuitry from multiple control planes based on a management configuration. The control configuration can specify resources (e.g., counters, meters, and so forth) and corresponding resources permitted to be accessed or configured by a particular control plane. The management configuration can be set by a management controller, orchestrator, data center administrator, software defined networking (SDN) controller, or others. Trusted processors can execute trusted software to perform resource allocation and management and setting of the management configuration.

In some examples, the circuitry can indicate failure to add a control configuration and identification of the control configuration that was failed to be applied to the data plane packet processing circuitry. In some examples, the circuitry can provide isolation between control planes and the data plane circuitry with configurable control for configuration rights of different control planes. The control configuration can be updated while traffic is being processed by the data plane circuitry, enabling run-time updates. In some examples, the circuitry can be utilized for flow validation of addresses and configuration rules. In some examples, the circuitry can be fabricated on a same semiconductor die as that of a packet processing pipeline of the network interface device.

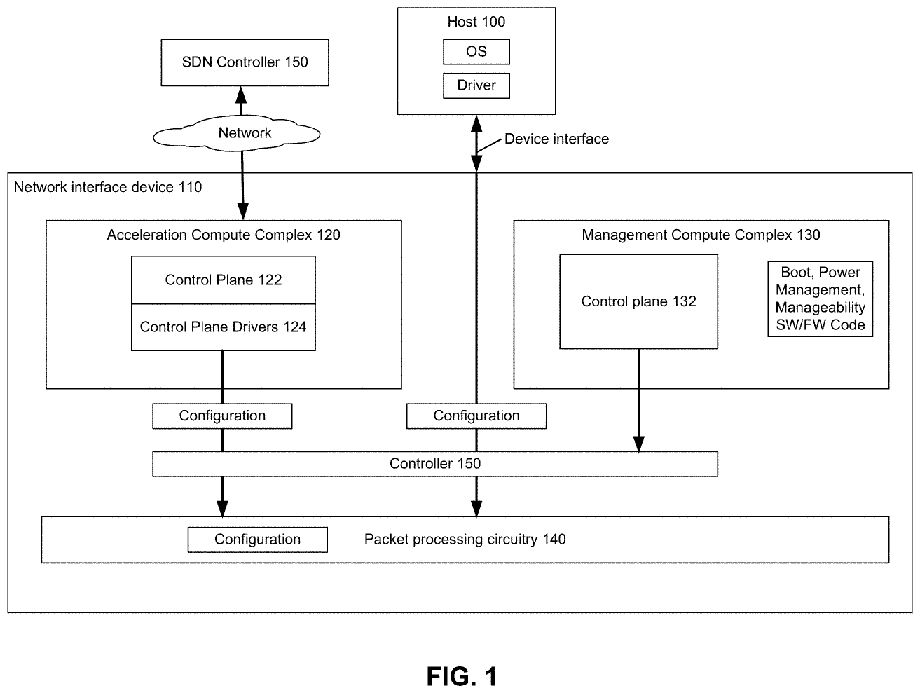

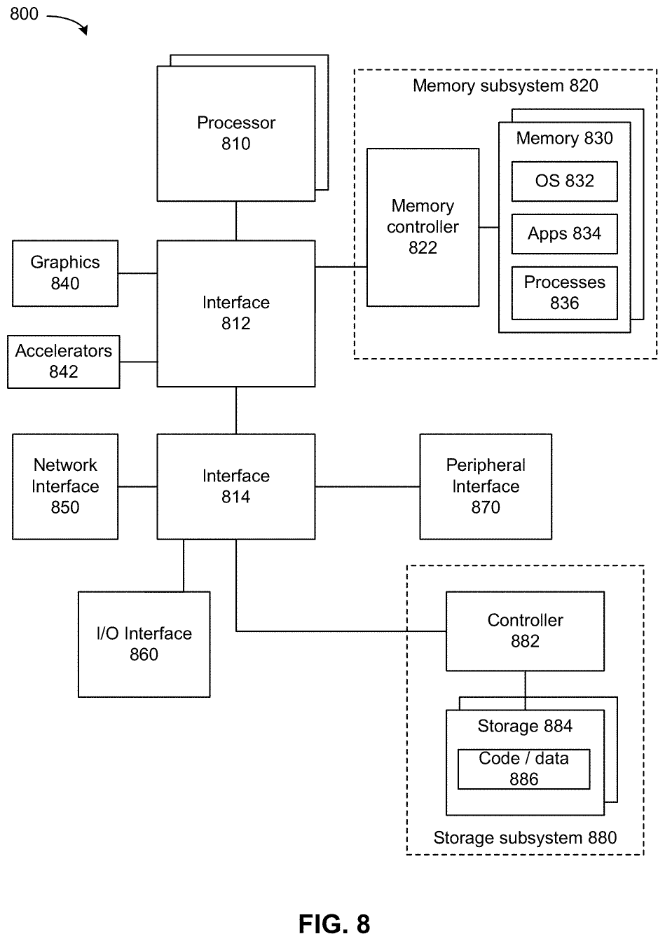

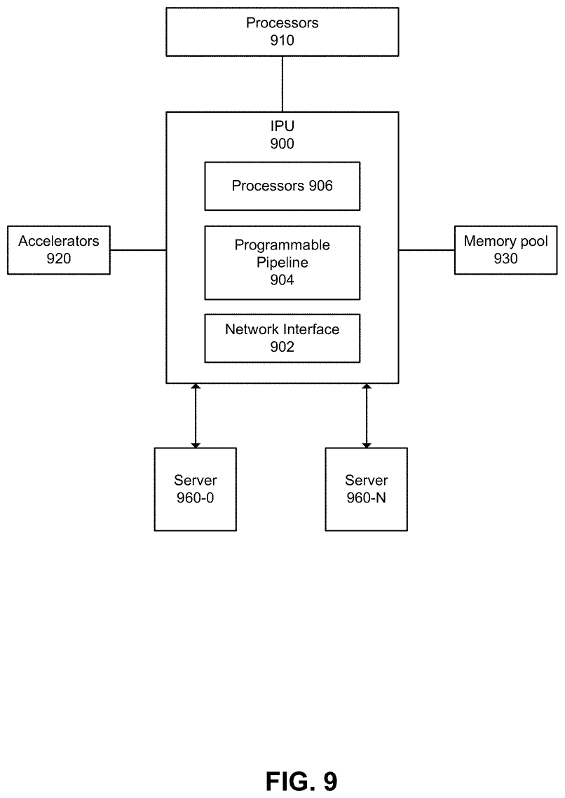

FIG. 1 depicts an example system. Host 100 can include one or more processors, one or more memory devices, one or more device interfaces, as well as other circuitry and software described at least with respect to FIG. 8 or 9. Processors of host 100 can execute software such as applications (e.g., microservices, virtual machine (VMs), microVMs, containers, processes, threads, or other virtualized execution environments), operating system (OS), and one or more device drivers. For example, an application executing on host 100 can utilize network interface device 110 to receive or transmit packet traffic. An OS or device driver can configure network interface device 110 to utilize one or more control planes to communicate with software defined networking (SDN) controller 150 via a network to configure operation of the one or more control planes.

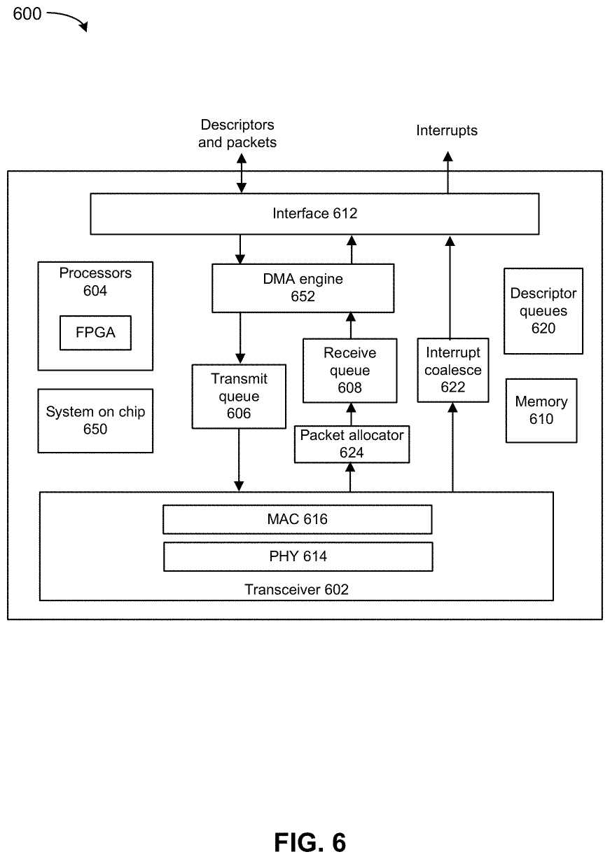

Network interface device 110 can be implemented as one or more of: a microprocessor, processor, accelerator, field programmable gate array (FPGA), application specific integrated circuit (ASIC) or circuitry or software described at least with respect to one or more of FIGS. 6-9. Network interface device 110 can include multiple compute complexes, such as an Acceleration Compute Complex (ACC) 120 and Management Compute Complex (MCC) 130, as well as controller 150, packet processing circuitry 140, and network interface technologies for communication with other devices via a network.

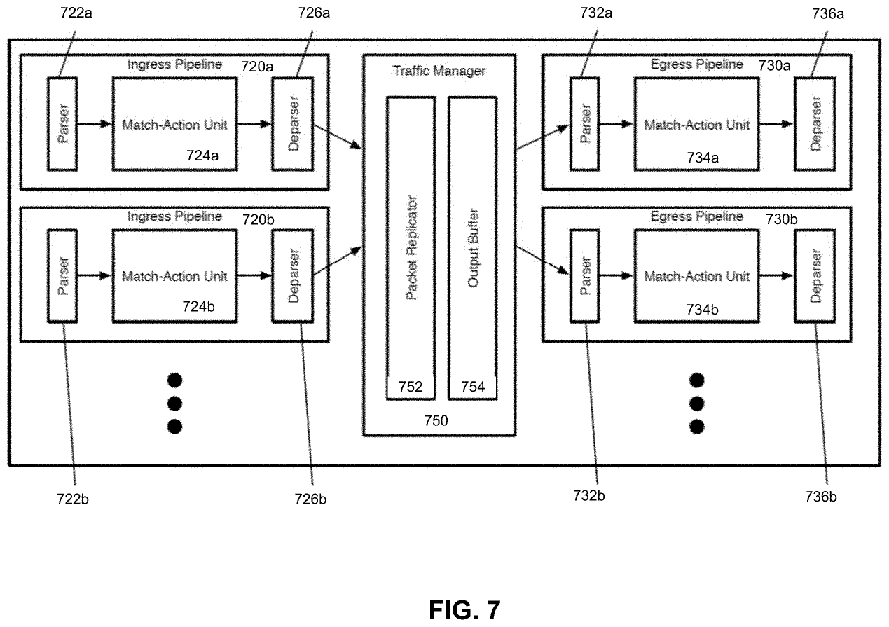

ACC 120 can be implemented as one or more of: a microprocessor, processor, accelerator, field programmable gate array (FPGA), application specific integrated circuit (ASIC) or circuitry described at least with respect to FIGS. 7-9. Similarly, MCC 130 can be implemented as one or more of: a microprocessor, processor, accelerator, field programmable gate array (FPGA), application specific integrated circuit (ASIC) or circuitry described at least with respect to one or more of FIGS. 7-9. In some examples, ACC 120 and MCC 130 can be implemented as different cores in a CPU, different cores in different CPUs, different processors in a same integrated circuit, or different processors in different integrated circuits.

Subject to approvals or denials of configurations by controller 150, packet processing circuitry 140 can process packets as directed or configured by one or more control planes executed by multiple compute complexes. In some examples, ACC 120 and MCC 130 can execute respective control planes 122 and 132 that request configuration of packet processing circuitry 140.

In some examples, SDN controller 150 can provide rules that control plane 122 executed by ACC 120 is to utilize to configure packet processing circuitry 140. For example, control plane 122 executed by ACC 120 can program table rules (e.g., header field match and corresponding action) applied by packet processing pipeline circuitry 140 based on change in policy and changes in VMs, containers, microservices, applications, or other processes.

Control plane 122 executed by ACC 120 can be configured to provide flow cache rules into a table to configure operation of packet processing pipeline 140. For example, the ACC-executed control plane application 122 can configure rule tables applied by packet processing pipeline circuitry 140 with rules to define a traffic destination based on packet type, flow identifier, and/or content. Control plane 122 executed by ACC 120 can program table rules (e.g., match-action) into memory accessible to packet processing pipeline circuitry 140 based on change in policy and changes in VMs. For example, control plane 122 executed by ACC 120 can configure packet processing pipeline circuitry 140 as to which VM is to receive traffic and what kind of traffic a VM can transmit. In some examples, packet processing pipeline circuitry 140 can execute a virtual switch such as vSwitch or Open vSwitch that provides communications between virtual machines executed by host 100 and network interface device 110.

A flow can be a sequence of packets being transferred between two endpoints, generally representing a single session using a protocol. Accordingly, a flow can be identified, using a match, by a set of defined tuples and, for routing purpose, a flow is identified by the two tuples that identify the endpoints, e.g., the source and destination addresses. For content-based services (e.g., load balancer, firewall, Intrusion detection system etc.), flows can be identified at a finer granularity by using N-tuples (e.g., source address, destination address, IP protocol, transport layer source port, and destination port). A packet in a flow is expected to have the same set of tuples in the packet header. A packet flow to be controlled can be identified by a combination of tuples (e.g., Ethernet type field, source and/or destination IP address, source and/or destination User Datagram Protocol (UDP) ports, source/destination Transmission Control Protocol (TCP) ports, or any other header field) and a unique source and destination queue pair (QP) number or identifier.

MCC 130 can execute a host management control plane, global resource manager, and perform configuration of hardware registers. Control plane 132 executed by MCC 130 can perform provisioning and configuration of packet processing circuitry 140. For example, a VM executing on host 100 can utilize network interface device 110 to receive, transmit, or process packet traffic. MCC 130 can execute boot, power, management, and manageability software (SW) or firmware (FW) code to boot and initialize the packet processing device 110, manage the device power consumption, provide connectivity to Baseboard Management Controller (B MC), and other operations.

Host 100 and ACC 120 (or other devices (e.g., MCC 130 and SDN controller 150)) can execute control planes that request configuration of packet processing circuitry 140. One or both of control planes executed by host 100 and ACC 120 can define traffic routing table content and network topology applied by packet processing circuitry 140 to select a path of a packet in a network to a next hop or to a destination network-connected device. Configuration of packet processing circuitry 140 can include configuration of table rules such as match-action entries for particular flow identifiers. Host 100 and ACC 120 can provide configuration by at least one packet or by writing to a queue associated with a source control plane. At least one packet can include a requester identifier (ID) that identifies a control plane that requests a configuration. A queue can be associated with a particular requester (e.g., control plane executed by host 100 or ACC 120) so that packet processing circuitry 140 identifies a requester's configuration by a queue that stores the requester's configuration.

Controller 150 can determine if a communication from host 100 or ACC 120 includes a configuration (control) or is to be transmitted (data packet). Controller 150 can determine if a configuration is permitted or not permitted based on a management configuration. MCC 130 can configure controller 150 with a management configuration to determine whether a control configuration from host 100 and ACC 120 is approved or rejected. In some examples, the control configuration can include a resource type identifier and associated resource identifier. Controller 150 can be implemented as one or more of: application specific integrated circuit (ASIC), field programmable gate array (FPGA), processors executing software, or other circuitry.

Packet processing circuitry 140 can be implemented using one or more of: application specific integrated circuit (ASIC), field programmable gate array (FPGA), processors executing software, or other circuitry. Various examples of packet processing pipeline circuitry 140 are described herein. Control plane 122 and a control plane executed by host 100 can configure packet processing pipeline circuitry 140 or other processors to perform operations related to issuances of non-volatile memory express (NVMe) reads or writes, issuances of Non-volatile Memory Express over Fabrics (NVMe-oF™) reads or writes, lookaside crypto Engine (LCE) (e.g., compression or decompression), Address Translation Engine (ATE) (e.g., input output memory management unit (IOMMU) to provide virtual-to-physical address translation), local area network (LAN) packet transmissions or receipts, compression/decompression, encryption/decryption, configuration as a storage node, configuration as a tenant hosting node, configuration as a compute node, provide multiple different types of services between different Peripheral Component Interconnect Express (PCIe) end points, or other accelerated operations. For example, a control configuration can be applied to high-frequency population use-cases (e.g., connection tracking for disaggregated firewall deployments).

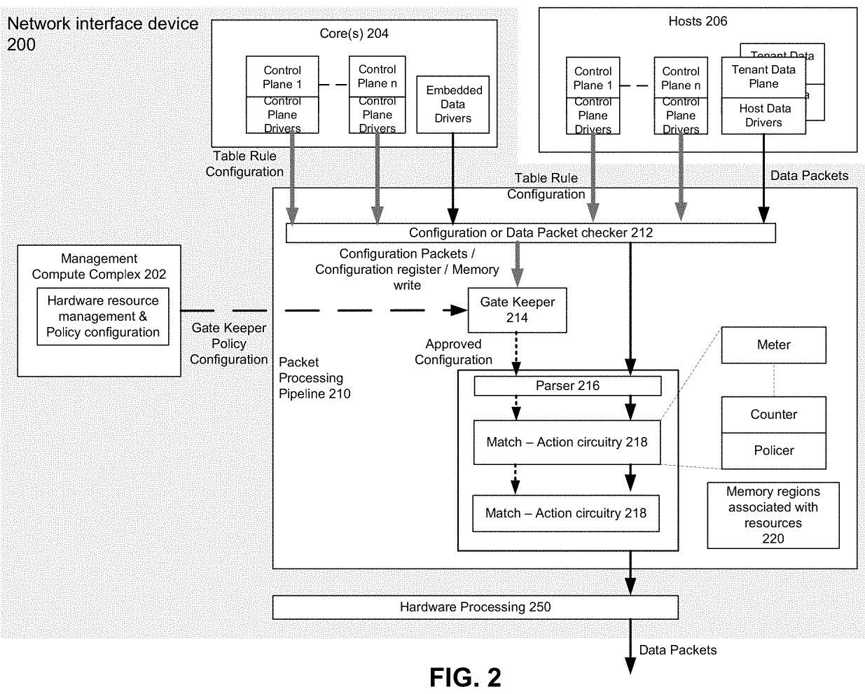

FIG. 2 depicts an example system. MCC 202 can issue a gate keeper policy configuration to gate keeper (controller) 214 to identify permitted configurations from control planes executed by processors (e.g., cores) 204 and host 206, and others. MCC 202 can configure gate keeper 214 with an access control list (ACL) to control modifications of configurations based on a source of the configuration. In response to receipt of a configuration or data from a control plane executed by cores 204 and host 206, configuration checker 212 can determine if a configuration or data packet was received. Based on receipt of a configuration, configuration checker 212 can provide the configuration to gate keeper 214. Based on receipt of a data packet, configuration checker 212 can provide the data packet to parser of packet processing pipeline 210.

As described herein, gate keeper 214 can determine whether the configuration is permitted based on the management or policy configuration from MCC 202. A management or policy configuration can indicate resource types and a range or list of resource values permitted for a source (e.g., control plane executed by cores 204 and host 206). For example, resources with a relatively low total number per device (e.g., hundreds or low thousands), such as hash function configuration profiles, can be allocated using lists. For example, resources with a relatively high total number per device (e.g., millions), can be allocated using ranges.

Various examples of resource types and resource identifier values are shown in Table 1.

TABLE 1

| Example resource type | Example resource identifier |
|---|---|
| Flow | Identifier of flow (e.g., N-tuple) |
| Counter | Identifier of register or memory that |
| | stores counter |
| Meter/policer | Identifier of register or memory that |
| | stores modifier/policer values |
| Wild card match profile | Profile value |
| Longest prefix match profile | Longest prefix match value |
| Longest exact match profile | Longest exact match value |
| Longest exact match aging flow | Longest exact match aging flow |
| | identifier |
| Packet Mirroring operation | Packet Mirroring index |
| Destination range checker | Permitted range of destination addresses |
| Table identifier (ID) | Identifier of register or memory that |
| | stores table |
| Virtual Station Identifier (VSI) | Permitted range of VSI |
| Queue | Identifier of register or memory that |
| | stores queue |

For example, a resource type can be counter identifier among a range of values of 15-715 and 6900-6938. A value for a counter can represent a region in memory or a register that stores a count value. A management configuration can indicate a control plane identifier that is permitted to utilize a counter and particular counter value. A counter can be associated with an action of a particular match-action circuitry, for example. For example, a resource type can be associated with an action of a match-action circuitry.

Permitted configurations can be provided to one or more match-action circuitry 218 to configure operations. Data packets can be provided to parser 216 and match-action circuitry 218 for processing and transmission. Match-action circuitry 218 can perform match-action operations in a pipelined or serial manner. Note that match-action circuitry 218 can process packets to be transmitted or received packets. Hardware processing 250 can include local area network (LAN), remote direct memory access (RDMA) processing, encryption/decryption, encapsulate packet to a tunnel, calculate and insert checksums on different levels such as L3 (e.g., Internet Protocol (IP)) or L4 (e.g., TCP or UDP), calculate hash of a packet to select to which port packet should be transmitted, and so on.

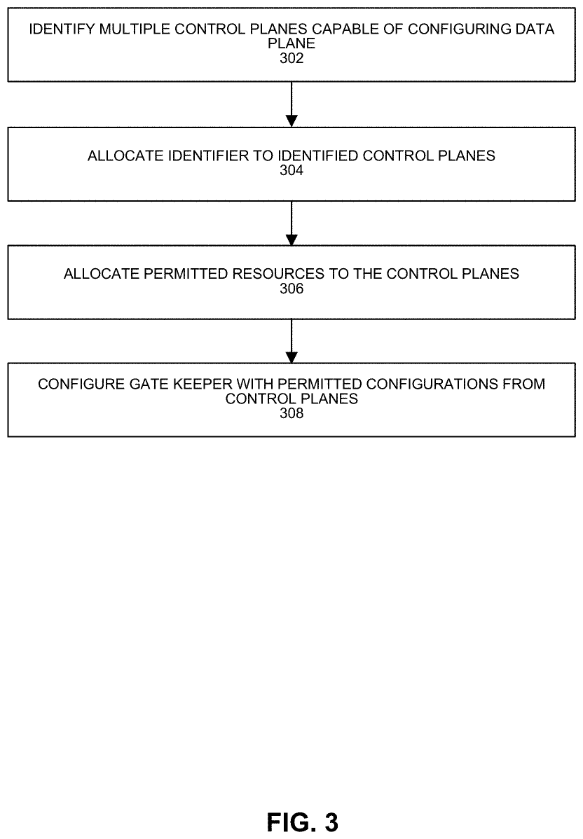

FIG. 3 depicts an example of operations of configuring a gate keeper. At 302, a management controller can discover different control planes in a system capable of configuring a data plane circuitry. For example, the management controller can identify a host and embedded compute complexes that execute control planes capable of configuring the data plane circuitry. For example, the management controller can identify different control planes from a provisioning or policy configuration file from an administrator and the control planes can be identified as a particular function type (e.g., virtual function (VF), physical function (PF)). At 304, the management controller can allocate a resources Partition Domain Index (PDID) to the discovered control planes. At 306, the management controller can allocate resources to the resource PDIDs. Resources can include one or more resource types described herein and can include table indexes, action indexes, profiles, virtual port indexes, etc.

At 308, the management controller can configure databases or tables utilized by a gatekeeper or controller that is to control which control plane is able to configure the data plane with particular configurations. For example, a control plane (CP) PDID match table can allocate a PDID for a {Function +source ID} entry. A PDID can be unique per {Function +source ID }. A function can be PCIe function whereas a source ID can be queue identifier. As described herein, databases or tables can identify allocated resource types and permitted range values for resource types per PDID. As described herein, databases or tables can identify allocated resources and permitted values of a resource per PDID.

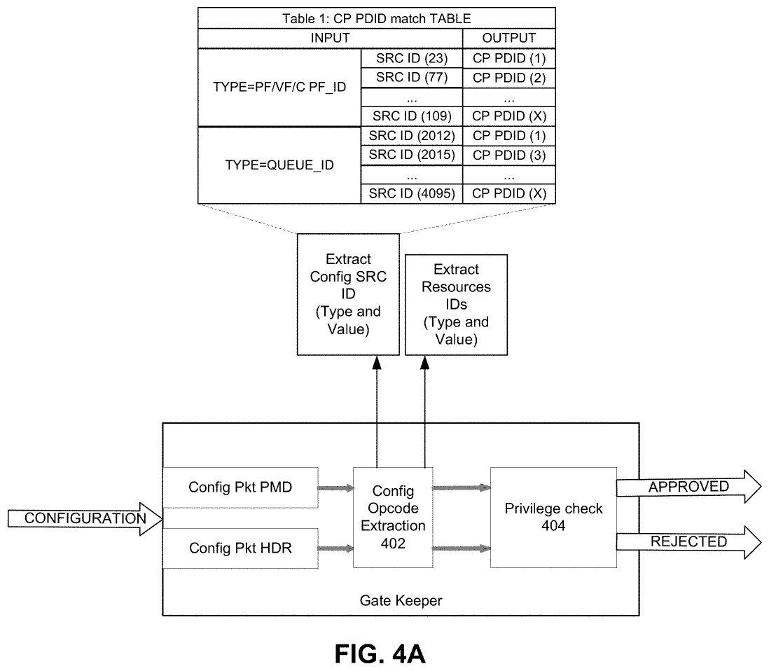

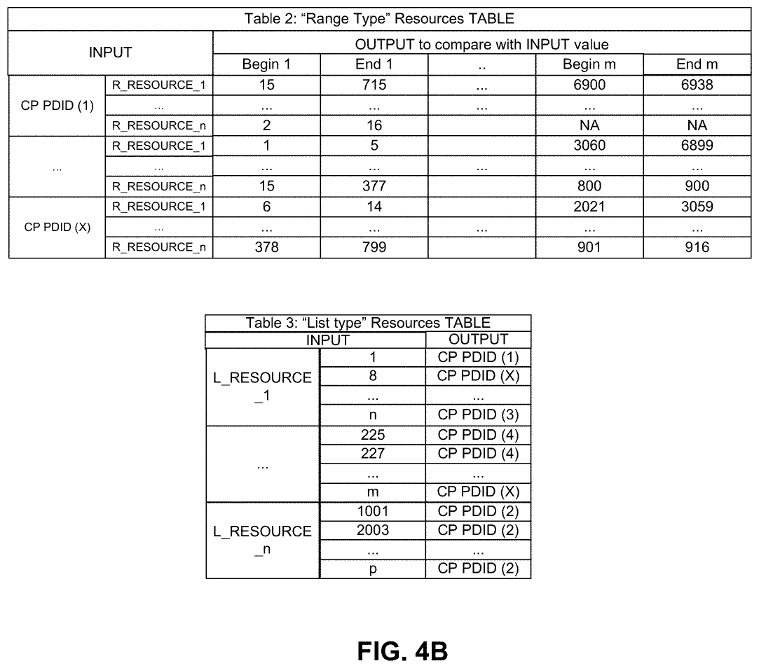

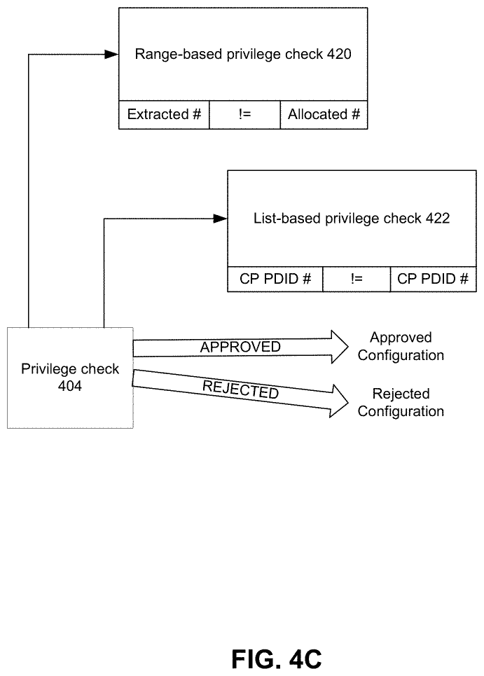

FIG. 4A depicts an example runtime flow of a gate keeper. A configuration can include a configuration packet header (e.g., Config Pkt HDR) and metadata (e.g., Config Pkt PMD). The configuration can be received from control planes executed by ACC or host, or other source. Config Opcode Extraction 402 can extract opcodes from the received configuration. Opcodes can include a configuration source identifier (e.g., Config SRC ID (Type and Value)), which can indicate a source of a request. A source of a request can identify a control plane and can include one or more of: type of source (e.g., physical function (PF), virtual function (VF), configuration physical function identifier (e.g., CPF_ID)), queue identifier that provided the configuration (e.g., QUEUE_ID), and source identifier of control plane that provided the configuration (e.g., SRC_ID).

For example, Config Opcode Extraction 402 can access a data structure such as Table 1 to determine a control plane identifier (e.g., CP PDID) corresponding to extracted source of request information. In some examples, a CP PDID value can be assigned to different source control planes where the different source control planes share resource setting privileges.

Privilege check 404 can perform a look up of resource setting privileges allocated to the source of the configuration based on a determined CP PDID value. Various examples of look up of resource setting privileges allocated to a source of the configuration are described herein.

FIG. 4B depicts an example of manners of determining resource setting privileges. For example, data such as Table 2 can be utilized to check a range of resources that are permitted to be modified for a particular requester identifier (e.g., CP PDID value) whereas data such as Table 3 can be utilized to check a list of resources that are permitted to be modified for a particular requester identifier (e.g., CP PDID value). For data such as Table 2, for a particular requester type identifier, a range of permitted resources and corresponding resource identifiers can be used by privilege check 404 to determine if the requester's configuration can be approved for configuring data plane packet processing circuitry. A resource identifier can refer to flow identifier, counter identifier, meter identifier, or other resources.

Data such as Table 3 can be used to identify a requester identifier(s) permitted to make a change for a particular requested resource and corresponding identifiers in a received configuration. In other words, data such as Table 3 can identify a list of requester identifiers that are permitted to make changes to particular resources and corresponding identifiers. The retrieved requester identifier can be used by privilege check to determine if the requester's configuration can be approved for configuring data plane packet processing circuitry.

FIG. 4C depicts an example of a privilege check based on permission data. For example, a privilege or permission check 420 can be performed to determine if a resource type and value are within a permitted range from a range lookup from data similar to that of Table 2. Based on a configuration including a resource type and value within a permitted range, the configuration request can be approved by privilege check 404. Based on a configuration including a resource type and value not within a permitted range, the configuration request can be rejected by privilege check 404.

For example, a privilege or permission check 422 can be performed for a retrieved requester identifier (e.g., CP PDID number) from a list lookup from data similar to that of Table 3. Based on a match of a CP PDID number from a list lookup with the CP PDID of the requester, the configuration can be approved by privilege check 404. Based on no match of the CP PDID of the requester with the CP PDID number from a list lookup, the configuration can be rejected by privilege check 404.

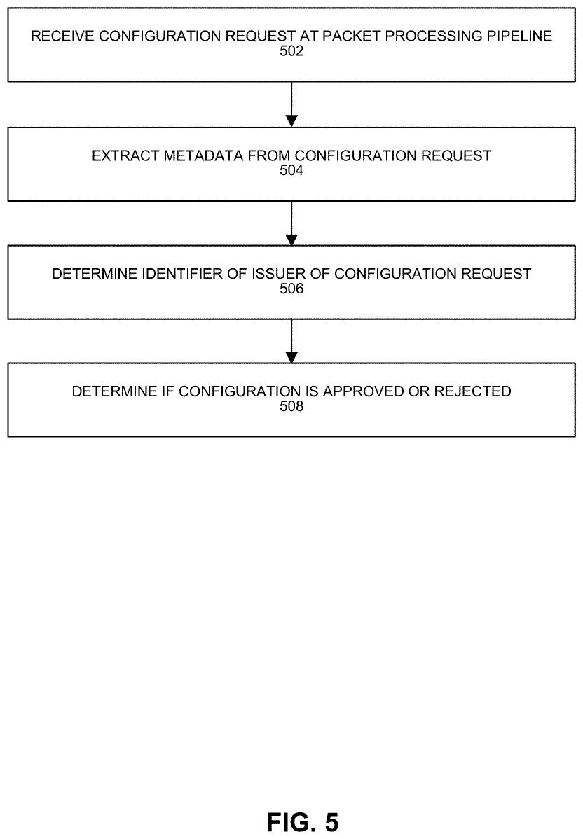

FIG. 5 depicts an example of runtime operations of a gate keeper. At 502, a configuration request can be received at a data plane packet processing circuitry. The configuration request can be written to a register, written to hardware mapped memory, or sent as one or more packets. The configuration request can include an indicator of resource type and resource identifier value or metadata uniquely identifying source of request and metadata and action for the configuration to be changed. At 504, the gate keeper can extract from the request metadata one or more of Function Type and Source ID. At 506, based on Function Type and Source ID, gate keeper can perform a lookup to determine an identifier of the requester.

At 508, the gate keeper can determine whether the configuration request is approved or rejected. For example, the gate keeper can determine whether the configuration request is approved based on a range of approved resource requests and identifier values for a requester identifier or determine if a particular resource request and identifier values is approved for a source identifier associated with the configuration request. For example, if the requester identifier matches a permitted requester identifier that corresponds to the resource request and identifier value, the configuration can be approved and provided to the data plane for configuration. For example, if the resource request and identifier is within a range of permitted resource(s) and requester identifier values, the configuration can be approved and provided for configuration of the data plane packet processing circuitry. If the requester identifier does not match a permitted requester identifier corresponding to the resource request and identifier values or the resource request and identifier is not within a range of permitted resource(s) and requester identifier values, the configuration request can be denied. A control plane or management entity can be contacted based on denial or rejection of the configuration request to identify the rejected configuration request.

FIG. 6 depicts an example network interface device or packet processing device. In some examples, configuration of the packet processing device can be programmed using multiple control planes executing on one or more of processors 604 based on approval of the configuration, as described herein. In some examples, packet processing device 600 can be implemented as a network interface controller, network interface card, a host fabric interface (HFI), or host bus adapter (HBA), and such examples can be interchangeable. Packet processing device 600 can be coupled to one or more servers using a bus, PCIe, CXL, or DDR. Packet processing device 600 may be embodied as part of a system-on-a-chip (SoC) that includes one or more processors, or included on a multichip package that also contains one or more processors.

Some examples of packet processing device 600 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface 600 can include transceiver 602, processors 604, transmit queue 606, receive queue 608, memory 610, and bus interface 612, and DMA engine 652. Transceiver 602 can be capable of receiving and transmitting packets in conformance with the applicable protocols such as Ethernet as described in IEEE 802.3, although other protocols may be used. Transceiver 602 can receive and transmit packets from and to a network via a network medium (not depicted). Transceiver 602 can include PHY circuitry 614 and media access control (MAC) circuitry 616. PHY circuitry 614 can include encoding and decoding circuitry (not shown) to encode and decode data packets according to applicable physical layer specifications or standards. MAC circuitry 616 can be configured to assemble data to be transmitted into packets, that include destination and source addresses along with network control information and error detection hash values.

Processors 604 can be any a combination of a: processor, core, graphics processing unit (GPU), field programmable gate array (FPGA), application specific integrated circuit (ASIC), or other programmable hardware device that allow programming of network interface 600. For example, a “smart network interface” can provide packet processing capabilities in the network interface using processors 604.

Processors 604 can include one or more packet processing pipeline that can be configured to perform match-action on received packets to identify packet processing rules and next hops using information stored in a ternary content-addressable memory (TCAM) tables or exact match tables in some embodiments. For example, match-action tables or circuitry can be used whereby a hash of a portion of a packet is used as an index to find an entry. Packet processing pipelines can perform one or more of: packet parsing (parser), exact match-action (e.g., small exact match (SEM) engine or a large exact match (LEM)), wildcard match-action (WCM), longest prefix match block (LPM), a hash block (e.g., receive side scaling (RSS)), a packet modifier (modifier), or traffic manager (e.g., transmit rate metering or shaping). For example, packet processing pipelines can implement access control list (ACL) or packet drops due to queue overflow.

Configuration of operation of processors 604, including its data plane, can be programmed based on one or more of: Protocol-independent Packet Processors (P4), Software for Open Networking in the Cloud (SONiC), Broadcom® Network Programming Language (NPL), NVIDIA® CUDA®, NVIDIA® DOCA™, Infrastructure Programmer Development Kit (IPDK), among others. Processors 604 and/or system on chip 650 can execute instructions to configure and utilize one or more circuitry as well as check against violation against use configurations, as described herein.

Packet allocator 624 can provide distribution of received packets for processing by multiple CPUs or cores using timeslot allocation described herein or RSS. When packet allocator 624 uses RSS, packet allocator 624 can calculate a hash or make another determination based on contents of a received packet to determine which CPU or core is to process a packet.

Interrupt coalesce 622 can perform interrupt moderation whereby network interface interrupt coalesce 622 waits for multiple packets to arrive, or for a time-out to expire, before generating an interrupt to host system to process received packet(s). Receive Segment Coalescing (RSC) can be performed by network interface 600 whereby portions of incoming packets are combined into segments of a packet. Network interface 600 provides this coalesced packet to an application.

Direct memory access (DMA) engine 652 can copy a packet header, packet payload, and/or descriptor directly from host memory to the network interface or vice versa, instead of copying the packet to an intermediate buffer at the host and then using another copy operation from the intermediate buffer to the destination buffer.

Memory 610 can be any type of volatile or non-volatile memory device and can store any queue or instructions used to program network interface 600. Transmit queue 606 can include data or references to data for transmission by network interface. Receive queue 608 can include data or references to data that was received by network interface from a network. Descriptor queues 620 can include descriptors that reference data or packets in transmit queue 606 or receive queue 608. Bus interface 612 can provide an interface with host device (not depicted). For example, bus interface 612 can be compatible with PCI, PCI Express, PCI-x, Serial ATA, and/or USB compatible interface (although other interconnection standards may be used).

FIG. 7 depicts an example packet processing pipeline that can be used in a switch, network device, or packet processing device. A packet processing pipeline can be configured by multiple control planes based on approval of a configuration or the configuration can be denied, as described herein. A packet processing pipeline several ingress pipelines 720, a traffic management unit (referred to as a traffic manager) 750, and several egress pipelines 730. Though shown as separate structures, in some examples the ingress pipelines 720 and the egress pipelines 730 can use the same circuitry resources. In some examples, the pipeline circuitry is configured to process ingress and/or egress pipeline packets synchronously, as well as non-packet data. That is, a particular stage of the pipeline may process any combination of an ingress packet, an egress packet, and non-packet data in the same clock cycle. However, in other examples, the ingress and egress pipelines are separate circuitry. In some of these other examples, the ingress pipelines also process the non-packet data.

Configuration of the packet processing pipeline by one or more control planes can take place based on approval of the configuration, as described herein. Configuration of operation of packet processing pipelines, including its data plane, can be programmed based on one or more of: Protocol-independent Packet Processors (P4), Software for Open Networking in the Cloud (SONiC), Broadcom® Network Programming Language (NPL), NVIDIA® CUDA®, NVIDIA® DOCA™, Infrastructure Programmer Development Kit (IPDK), among others.

In some examples, in response to receiving a packet, the packet is directed to one of the ingress pipelines 720 where an ingress pipeline which may correspond to one or more ports of a hardware forwarding element. After passing through the selected ingress pipeline 720, the packet is sent to the traffic manager 750, where the packet is enqueued and placed in the output buffer 754. In some examples, the ingress pipeline 720 that processes the packet specifies into which queue the packet is to be placed by the traffic manager 750 (e.g., based on the destination of the packet or a flow identifier of the packet). The traffic manager 750 then dispatches the packet to the appropriate egress pipeline 730 where an egress pipeline may correspond to one or more ports of the forwarding element. In some examples, there is no necessary correlation between which of the ingress pipelines 720 processes a packet and to which of the egress pipelines 730 the traffic manager 750 dispatches the packet. That is, a packet might be initially processed by ingress pipeline 720b after receipt through a first port, and then subsequently by egress pipeline 730a to be sent out a second port, etc.

A least one ingress pipeline 720 includes a parser 722, plural match-action units (MAUs) 724, and a deparser 726. Similarly, egress pipeline 730 can include a parser 732, plural MAUs 734, and a deparser 736. The parser 722 or 732, in some examples, receives a packet as a formatted collection of bits in a particular order, and parses the packet into its constituent header fields. In some examples, the parser starts from the beginning of the packet and assigns header fields to fields (e.g., data containers) for processing. In some examples, the parser 722 or 732 separates out the packet headers (up to a designated point) from the payload of the packet, and sends the payload (or the entire packet, including the headers and payload) directly to the deparser without passing through the MAU processing.

MAUs 724 or 734 can perform processing on the packet data. In some examples, MAUs includes a sequence of stages, with a stage including one or more match tables and an action engine. A match table can include a set of match entries against which the packet header fields are matched (e.g., using hash tables), with the match entries referencing action entries. When the packet matches a particular match entry, that particular match entry references a particular action entry which specifies a set of actions to perform on the packet (e.g., sending the packet to a particular port, modifying one or more packet header field values, dropping the packet, mirroring the packet to a mirror buffer, etc.). The action engine of the stage can perform the actions on the packet, which is then sent to the next stage of the MAU. For example, MAU(s) can be used to determine whether to migrate data to another memory device and select another memory device, as described herein.

Deparser 726 or 736 can reconstruct the packet using a packet header vector (PHV) or other metadata as modified by the MAU 724 or 734 and the payload received directly from the parser 722 or 732. The deparser can construct a packet that can be sent out over the physical network, or to the traffic manager 750. In some examples, the deparser can construct this packet based on data received along with the PHV that specifies the protocols to include in the packet header, as well as its own stored list of data container locations for possible protocol's header fields.

Traffic manager 750 can include a packet replicator 752 and output buffer 754. In some examples, the traffic manager 750 may include other components, such as a feedback generator for sending signals regarding output port failures, a series of queues and schedulers for these queues, queue state analysis components, as well as additional components. The packet replicator 752 of some examples performs replication for broadcast/multicast packets, generating multiple packets to be added to the output buffer (e.g., to be distributed to different egress pipelines).

Output buffer 754 can be part of a queuing and buffering system of the traffic manager in some examples. The traffic manager 750 can provide a shared buffer that accommodates any queuing delays in the egress pipelines. In some examples, this shared output buffer 754 can store packet data, while references (e.g., pointers) to that packet data are kept in different queues for egress pipeline 730. The egress pipelines can request their respective data from the common data buffer using a queuing policy that is control-plane configurable. When a packet data reference reaches the head of its queue and is scheduled for dequeuing, the corresponding packet data can be read out of the output buffer 754 and into the corresponding egress pipeline 730. In some examples, packet data may be referenced by multiple pipelines (e.g., for a multicast packet). In this case, the packet data is not removed from this output buffer 754 until references to the packet data have cleared their respective queues.

FIG. 8 depicts a system. In some examples, operation of programmable pipelines of network interface 850 can be programmed using multiple control planes executing on one or more processors (e.g., one or more of processor 810 or one or more processors in network interface 850) based on approval of the configuration or the configuration can be denied, as described herein. System 800 includes processor 810, which provides processing, operation management, and execution of instructions for system 800. Processor 810 can include any type of microprocessor, central processing unit (CPU), graphics processing unit (GPU), XPU, processing core, or other processing hardware to provide processing for system 800, or a combination of processors. An XPU can include one or more of: a CPU, a graphics processing unit (GPU), general purpose GPU (GPGPU), and/or other processing units (e.g., accelerators or programmable or fixed function FPGAs). Processor 810 controls the overall operation of system 800, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 800 includes interface 812 coupled to processor 810, which can represent a higher speed interface or a high throughput interface for system components that needs higher bandwidth connections, such as memory subsystem 820 or graphics interface components 840, or accelerators 842. Interface 812 represents an interface circuit, which can be a standalone component or integrated onto a processor die. Where present, graphics interface 840 interfaces to graphics components for providing a visual display to a user of system 800. In one example, graphics interface 840 can drive a display that provides an output to a user. In one example, the display can include a touchscreen display. In one example, graphics interface 840 generates a display based on data stored in memory 830 or based on operations executed by processor 810 or both. In one example, graphics interface 840 generates a display based on data stored in memory 830 or based on operations executed by processor 810 or both.

Accelerators 842 can be a programmable or fixed function offload engine that can be accessed or used by a processor 810. For example, an accelerator among accelerators 842 can provide data compression (DC) capability, cryptography services such as public key encryption (PKE), cipher, hash/authentication capabilities, decryption, or other capabilities or services. In some embodiments, in addition or alternatively, an accelerator among accelerators 842 provides field select controller capabilities as described herein. In some cases, accelerators 842 can be integrated into a CPU socket (e.g., a connector to a motherboard or circuit board that includes a CPU and provides an electrical interface with the CPU). For example, accelerators 842 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 842 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 820 represents the main memory of system 800 and provides storage for code to be executed by processor 810, or data values to be used in executing a routine. Memory subsystem 820 can include one or more memory devices 830 such as read-only memory (ROM), flash memory, one or more varieties of random access memory (RAM) such as DRAM, or other memory devices, or a combination of such devices. Memory 830 stores and hosts, among other things, operating system (OS) 832 to provide a software platform for execution of instructions in system 800. Additionally, applications 834 can execute on the software platform of OS 832 from memory 830. Applications 834 represent programs that have their own operational logic to perform execution of one or more functions. Processes 836 represent agents or routines that provide auxiliary functions to OS 832 or one or more applications 834 or a combination. OS 832, applications 834, and processes 836 provide software logic to provide functions for system 800. In one example, memory subsystem 820 includes memory controller 822, which is a memory controller to generate and issue commands to memory 830. It will be understood that memory controller 822 could be a physical part of processor 810 or a physical part of interface 812. For example, memory controller 822 can be an integrated memory controller, integrated onto a circuit with processor 810.

Applications 834 and/or processes 836 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

A virtualized execution environment (VEE) can include at least a virtual machine or a container. A virtual machine (VM) can be software that runs an operating system and one or more applications. A VM can be defined by specification, configuration files, virtual disk file, non-volatile random access memory (NVRAM) setting file, and the log file and is backed by the physical resources of a host computing platform. A VM can include an operating system (OS) or application environment that is installed on software, which imitates dedicated hardware. The end user has the same experience on a virtual machine as they would have on dedicated hardware. Specialized software, called a hypervisor, emulates the PC client or server's CPU, memory, hard disk, network and other hardware resources completely, enabling virtual machines to share the resources. The hypervisor can emulate multiple virtual hardware platforms that are isolated from another, allowing virtual machines to run Linux®, Windows® Server, VMware ESXi, and other operating systems on the same underlying physical host. In some examples, an operating system can issue a configuration to a data plane of network interface 850.

A container can be a software package of applications, configurations and dependencies so the applications run reliably on one computing environment to another. Containers can share an operating system installed on the server platform and run as isolated processes. A container can be a software package that contains everything the software needs to run such as system tools, libraries, and settings. Containers may be isolated from the other software and the operating system itself. The isolated nature of containers provides several benefits. First, the software in a container will run the same in different environments. For example, a container that includes PHP and MySQL can run identically on both a Linux® computer and a Windows® machine. Second, containers provide added security since the software will not affect the host operating system. While an installed application may alter system settings and modify resources, such as the Windows registry, a container can only modify settings within the container.

In some examples, OS 832 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

While not specifically illustrated, it will be understood that system 800 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 800 includes interface 814, which can be coupled to interface 812. In one example, interface 814 represents an interface circuit, which can include standalone components and integrated circuitry. In one example, multiple user interface components or peripheral components, or both, couple to interface 814. Network interface 850 provides system 800 the ability to communicate with remote devices (e.g., servers or other computing devices) over one or more networks. Network interface 850 can include an Ethernet adapter, wireless interconnection components, cellular network interconnection components, USB (universal serial bus), or other wired or wireless standards-based or proprietary interfaces. Network interface 850 can transmit data to a device that is in the same data center or rack or a remote device, which can include sending data stored in memory. Network interface 850 can receive data from a remote device, which can include storing received data into memory. In some examples, network interface 850 can refer to one or more of: a network interface controller (NIC), a remote direct memory access (RDMA)-enabled NIC, SmartNlC, router, switch, forwarding element, infrastructure processing unit (IPU), or data processing unit (DPU). An example IPU or DPU is described with respect to FIG. 9.

In some examples, configuration of programmable pipelines of network interface 850 can be programmed using multiple control planes executing on one or more processors (e.g., one or more of processor 810 or one or more processors in network interface 850) based on approval of the configuration, as described herein.

In one example, system 800 includes one or more input/output (I/O) interface(s) 860. I/O interface 860 can include one or more interface components through which a user interacts with system 800 (e.g., audio, alphanumeric, tactile/touch, or other interfacing). Peripheral interface 870 can include any hardware interface not specifically mentioned above. Peripherals refer generally to devices that connect dependently to system 800. A dependent connection is one where system 800 provides the software platform or hardware platform or both on which operation executes, and with which a user interacts.

In one example, system 800 includes storage subsystem 880 to store data in a nonvolatile manner. In one example, in certain system implementations, at least certain components of storage 880 can overlap with components of memory subsystem 820. Storage subsystem 880 includes storage device(s) 884, which can be or include any conventional medium for storing large amounts of data in a nonvolatile manner, such as one or more magnetic, solid state, or optical based disks, or a combination. Storage 884 holds code or instructions and data 886 in a persistent state (e.g., the value is retained despite interruption of power to system 800). Storage 884 can be generically considered to be a “memory,” although memory 830 is typically the executing or operating memory to provide instructions to processor 810. Whereas storage 884 is nonvolatile, memory 830 can include volatile memory (e.g., the value or state of the data is indeterminate if power is interrupted to system 800). In one example, storage subsystem 880 includes controller 882 to interface with storage 884. In one example controller 882 is a physical part of interface 814 or processor 810 or can include circuits or logic in both processor 810 and interface 814.

A volatile memory is memory whose state (and therefore the data stored in it) is indeterminate if power is interrupted to the device. Dynamic volatile memory requires refreshing the data stored in the device to maintain state. One example of dynamic volatile memory incudes DRAM (Dynamic Random Access Memory), or some variant such as Synchronous DRAM (SDRAM). Another example of volatile memory includes cache or static random access memory (SRAM).

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), Intel® Optane™ memory, or NVM devices that use chalcogenide phase change material (for example, chalcogenide glass).

A power source (not depicted) provides power to the components of system 800. More specifically, power source typically interfaces to one or multiple power supplies in system 800 to provide power to the components of system 800. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 800 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (COX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications. A die-to-die communications can utilize Embedded Multi-Die Interconnect Bridge (EMIB) or an interposer.

In an example, system 800 can be implemented using interconnected compute sleds of processors, memories, storages, network interfaces, and other components. High speed interconnects can be used such as PCIe, Ethernet, or optical interconnects (or a combination thereof).

Embodiments herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

FIG. 9 depicts an example system. In this system, IPU 900 manages performance of one or more processes using one or more of processors 906, processors 910, accelerators 920, memory pool 930, or servers 940-0 to 940-N, where N is an integer of 1 or more. In some examples, processors 906 of IPU 900 can execute one or more processes, applications, VMs, containers, microservices, and so forth that request performance of workloads by one or more of: processors 910, accelerators 920, memory pool 930, and/or servers 940-0 to 940-N. IPU 900 can utilize network interface 902 or one or more device interfaces to communicate with processors 910, accelerators 920, memory pool 930, and/or servers 940-0 to 940-N. IPU 900 can utilize programmable pipeline 904 to process packets that are to be transmitted from network interface 902 or packets received from network interface 902.

In some examples, programmable pipelines 904 can be programmed using one or more control planes executing on one or more processors (e.g., one or more of processors 906) based on approval of the configuration or the configuration can be denied, as described herein.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.′”

Illustrative examples of the devices, systems, and methods disclosed herein are provided below. An embodiment of the devices, systems, and methods may include any one or more, and any combination of, the examples described below.

Example 1 includes one or more examples, and includes an apparatus comprising: a network interface device comprising circuitry and data plane circuitry, wherein: the circuitry is to receive control configurations from multiple control planes and based on a management configuration, selectively deny a control configuration of the received control configurations to configure operations of the data plane circuitry.

Example 2 includes one or more examples, wherein selectively deny the control configuration comprises restrict different control planes from modification of configuration of the data plane circuitry

Example 3 includes one or more examples, wherein at least one control plane of the multiple control planes comprises a control plane of an application.

Example 4 includes one or more examples, wherein the management configuration is to specify a resource and associated resource identifier permitted to be modified by a control plane.

Example 5 includes one or more examples, wherein the management configuration is to identify permitted control configuration content based on at least one permitted control plane and at least one range of permitted associated resource identifiers.

Example 6 includes one or more examples, wherein the management configuration is to identify permitted control configuration content based on at least one permitted control plane and at least one list of permitted associated resource identifiers.

Example 7 includes one or more examples, wherein the control configurations request to configure match-action operations of the data plane circuitry.

Example 8 includes one or more examples, wherein the control configurations request to configure the data plane circuitry to perform operations related to one or more of: counters, modifiers, meters, policers, wild card match, long prefix match, long exact match, long exact match aging, packet mirroring, range check, table, virtual state identifier (VSI), or queue.

Example 9 includes one or more examples, wherein the network interface device comprises one or more of: a network interface controller (NIC), a remote direct memory access (RDMA)-enabled NIC, SmartNlC, router, switch, forwarding element, infrastructure processing unit (IPU), or data processing unit (DPU).

Example 10 includes one or more examples, and includes a server communicatively couple to the network interface device to provide at least one of the control configurations.

Example 11 includes one or more examples, and includes a computer-readable medium comprising instructions stored thereon, that if executed by one or more processors, cause the one or more processors to: configure a data plane circuitry of a network interface device to deny control plane configurations from multiple control planes executed by multiple processors based on a management configuration.

Example 12 includes one or more examples, wherein the network interface device comprises at least one processor to provide the control plane configuration.

Example 13 includes one or more examples, wherein the management configuration is to specify a resource and associated resource identifier permitted to be modified by a control plane.

Example 14 includes one or more examples, wherein the management configuration is to identify permitted control configuration content based on at least one permitted control plane and at least one permitted associated resource identifier.

Example 15 includes one or more examples, wherein the management configuration is provided by a management controller.

Example 16 includes one or more examples, wherein the control configurations request to configure match-action operations of the data plane circuitry.

Example 17 includes one or more examples, and includes a method comprising: receiving control configurations from a first control plane and a second control plane and based on a management configuration, denying the control configurations for setting operation of a data plane packet processing circuitry.

Example 18 includes one or more examples, wherein the management configuration is to specify a resource and associated resource identifier permitted to be modified by a control plane.

Example 19 includes one or more examples, wherein the management configuration is to identify control configuration content to deny based on at least one permitted control plane and at least one permitted associated resource identifier.

Example 20 includes one or more examples, wherein the control configurations request to configure match-action operations of the data plane circuitry.

Example 21 includes one or more examples, wherein the control configurations request to configure the data plane circuitry to perform operations related to one or more of: counters, modifiers, meters, policers, wild card match, long prefix match, long exact match, long exact match aging, packet mirroring, range check, table, virtual state identifier (VSI), or queue.

What is claimed is:

1. An apparatus comprising:
a network interface device comprising circuitry and data plane circuitry, wherein:
the circuitry is to receive control configurations from multiple control planes and based on a management configuration, selectively deny a control configuration of the received control configurations to configure operations of the data plane circuitry.

2. The method of claim 1, wherein selectively deny the control configuration comprises restrict different control planes from modification of configuration of the data plane circuitry

3. The method of claim 1, wherein at least one control plane of the multiple control planes comprises a control plane of an application.

4. The apparatus of claim 1, wherein the management configuration is to specify a resource and associated resource identifier permitted to be modified by a control plane.

5. The apparatus of claim 1, wherein the management configuration is to identify permitted control configuration content based on at least one permitted control plane and at least one range of permitted associated resource identifiers.

6. The apparatus of claim 1, wherein the management configuration is to identify permitted control configuration content based on at least one permitted control plane and at least one list of permitted associated resource identifiers.

7. The apparatus of claim 1, wherein the control configurations request to configure match-action operations of the data plane circuitry.

8. The apparatus of claim 1, wherein the control configurations request to configure the data plane circuitry to perform operations related to one or more of: counters, modifiers, meters, policers, wild card match, long prefix match, long exact match, long exact match aging, packet mirroring, range check, table, virtual state identifier (VSI), or queue.

9. The apparatus of claim 1, wherein the network interface device comprises one or more of: a network interface controller (NIC), a remote direct memory access (RDMA)-enabled NIC, SmartNlC, router, switch, forwarding element, infrastructure processing unit (IPU), or data processing unit (DPU).

10. The apparatus of claim 1, comprising a server communicatively couple to the network interface device to provide at least one of the control configurations.

11. A computer-readable medium comprising instructions stored thereon, that if executed by one or more processors, cause the one or more processors to:
configure a data plane circuitry of a network interface device to deny control plane configurations from multiple control planes executed by multiple processors based on a management configuration.

12. The computer-readable medium of claim 11, wherein the network interface device comprises at least one processor to provide the control plane configuration.

13. The computer-readable medium of claim 11, wherein the management configuration is to specify a resource and associated resource identifier permitted to be modified by a control plane.

14. The computer-readable medium of claim 11, wherein the management configuration is to identify permitted control configuration content based on at least one permitted control plane and at least one permitted associated resource identifier.

15. The computer-readable medium of claim 11, wherein the management configuration is provided by a management controller.

16. The computer-readable medium of claim 11, wherein the control configurations request to configure match-action operations of the data plane circuitry.

17. A method comprising:
receiving control configurations from a first control plane and a second control plane and
based on a management configuration, denying the control configurations for setting operation of a data plane packet processing circuitry.

18. The method of claim 17, wherein the management configuration is to specify a resource and associated resource identifier permitted to be modified by a control plane.

19. The method of claim 17, wherein the management configuration is to identify control configuration content to deny based on at least one permitted control plane and at least one permitted associated resource identifier.

20. The method of claim 17, wherein the control configurations request to configure match-action operations of the data plane circuitry.

21. The method of claim 17, wherein the control configurations request to configure the data plane circuitry to perform operations related to one or more of: counters, modifiers, meters, policers, wild card match, long prefix match, long exact match, long exact match aging, packet mirroring, range check, table, virtual state identifier (VSI), or queue.
